(19) United States
(12) Patent Application Publication
(10) Pub. No.: US 2023/0295384 A1
(43) Pub. Date: Sep. 21, 2023

(54) POLYMER PARTICLE MANUFACTURING METHOD, METHOD OF OBTAINING LIQUID MIXTURE INCLUDING POLYMER PARTICLES AND ORGANOTELLURIUM COMPOUND, TELLURIUM RECOVERY METHOD, AND DISPERSION OF POLYMER PARTICLES

(71) Applicant: KYOTO UNIVERSITY, Kyoto-shi, Kyoto (JP)

(72) Inventors: Shigeru YAMAGO, Kyoto (JP); Masatoshi TOSAKA, Kyoto (JP)

(21) Appl. No.: 17/998,439

(22) PCT Filed: May 11, 2021
(86) PCT No.: PCT/JP2021/017950

§ 371 Date: Jun. 9, 2023

(30) Foreign Application Priority Data
May 11, 2020 (JP) 2020-083509

(51) Int. Cl. C08J 5/02

(52) U.S. Cl. CPC C08J 5/02; C08J 2325/06

(57) ABSTRACT

A polymer particle manufacturing method according to the present invention includes: (i) mixing a dispersion A5 of polymer particles A3 with a reactant, the dispersion A5 including the polymer particles A3 and a first solvent 4 in which the polymer particles A3 are dispersed, the polymer particles A3 being formed from a structurally controlled polymer having an organotellurium group 1 at a growing end thereof, the polymer being synthesized by an emulsion polymerization with use of a first organotellurium compound as a polymerization control agent, the reactant being soluble in the first solvent 4; and removing the organotellurium group 1 from the growing end of the polymer to obtain a liquid mixture 8 including a second organotellurium compound 6 generated by a reaction between the reactant and the organotellurium group 1 and polymer particles B7 having an organotellurium group 1 reduced relative to the organotellurium group 1 in the polymer particles A3; and (ii) separating, from the liquid mixture 8, the polymer particles B7 and a solution 9 in which the second organotellurium compound 6 is dissolved from each other.

### TECHNICAL FIELD

The present invention relates to a polymer particle manufacturing method of manufacturing polymer particles formed from a structurally controlled polymer, a method of obtaining a liquid mixture including polymer particles and an organotellurium compound, a tellurium recovery method, and a dispersion of polymer particles.

### BACKGROUND ART

Living radical polymerization processes, which are referred to also as reversible inactivation radical polymerizations, are excellent polymerization processes that have both a feature of radical polymerization processes, namely, a high versatility, and a feature of living polymerization processes, namely, a capability of controlling the structure such as the molecular weight and molecular weight distribution of the polymer to be synthesized. This leads to a recent high attention to the living radical polymerization processes, and various living radical polymerization processes have been proposed. Among the living radical polymerization processes, the organotellurium-mediated living radical polymerization (TERP) process, which is a living radical polymerization process using an organotellurium compound as the polymerization control agent, is a particularly useful polymerization process in having an extremely high versatility that it is applicable to various monomers and in capable of highly controlling the molecular weights and molecular weight distributions of polymers.

Emulsion polymerizations have been widely used in conventional radical polymerizations as a method of conveniently obtaining polymer particles having controlled particle diameters, and the obtained polymer particles and a dispersion of the polymer particles have been useful as polymer materials in many application fields. However, it has been difficult to control the structure of the polymer chains forming the polymer particles. An extremely useful method has been recently proposed according to which a polymerization process of developing the TERP process to an emulsion polymerization in water, namely, a synthesis in a heterogeneous system not only enables a high control on the molecular weight and molecular weight distribution of the polymer to be synthesized but also enables a control on the particle diameters of the polymer particles formed from the polymer to be synthesized (Non Patent Literatures 1 and 2).

A polymer synthesized by the TERP process has an organotellurium group bonded to its growing end. On the other hand, since tellurium compounds present potential concerns for its toxicity, any effective method is necessary for removing and separating the organotellurium group from the polymer. Further, the tellurium element is a rare element, and moreover its utility value as, for example, the material for solar cells also has increased in recent years. This generates a desire to be capable of not only simply separating an organotellurium group from a polymer but also recovering the organotellurium group.

A method has been proposed for removing, from a polymer synthesized in a homogeneous solution system by the TERP process, an organotellurium group bonded to the growing end of the polymer (Patent Literatures 1 and 2). According to this method, an organic tellurol compound is used as the reductant and a ditelluride compound generated by a reduction of the synthesized polymer is separated by a liquid-liquid extraction method, so that organotellurium group is removed from the polymer. Further, a method using a solid-liquid extraction method has also been proposed according to which an organotellurium group is cleaved from the polymer with a thiol or the like, a solvent having a low affinity for the polymer is added to aggregate the polymer, so that that the organotellurium group is separated and recovered (Non Patent Literature 3). However, it is impossible to generate, from the polymer isolated by these methods, polymer particles having controlled particle diameters as is obtained by an emulsion polymerization.

### CITATION LIST

### Patent Literature

Patent Literature 1: JP 2017-200882 A
Patent Literature 2: JP 2017-200961 A

### Non Patent Literature

Non Patent Literature 1: Fan, W, Tosaka, M., Yamago, S., Cunnigham, M. F. “Living ab initio Emulsion Polymerization of Methyl Methacrylate in Water Using a Water Soluble Organotellurium Chain Transfer Agent under Thermal and Photochemical Conditions”, Angew. Chem. Int. Ed. 2018, 57, 962-966
Non Patent Literature 2: Sugihara, Y, Yamago, S., Zetterlund, Per B. “An Innovative Approach to Implementation of Organotellurium-Mediated Radical Polymerization (TERP) in Emulsion Polymerization”, Macromolecules 2015, 48, 4312-4318
Non Patent Literature 3: Yamago, S., Matsumoto, A., “Arylthiols as Highly Chemoselective and Environmentally Benign Radical Reducing Agents”, J. Org. Chem. 2008, 73, 7300-7304

### SUMMARY OF INVENTION

### Technical Problem

Even in polymer particles formed from a structurally controlled polymer synthesized by an emulsion polymerization using the TERP process, the polymer has an organotellurium group bonded to its growing end. Accordingly, from the viewpoint of effective utilization of polymer particles and tellurium, an effective method is required for removing, from polymer particles formed from a polymer synthesized by an emulsion polymerization using the TERP process, an organotellurium group while maintaining the polymer particle shapes. The structurally controlled polymer refers to a polymer that is a linear polymer having a molecular weight dispersity of 1 or more and 2 or less, more preferably 1 or more and 1.5 or less and a polymer that is branched polymer having a molecular weight dispersity of 1 or more and 4 or less, more preferably 1 or more and 2 or less.

However, there has been no effective method yet according to which, as for polymer particles obtained by an emulsion polymerization using the TERP process, an organotellurium group can be separated and recovered from a polymer without losing a useful feature achieved by the emulsion polymerization, namely, without losing controlled polymer particle shapes. For example, to apply the method described in Patent Literatures 1 and 2, which are used for polymers synthesized in a homogeneous solution system by the TERP process and the method described in Non Patent Literatures 1 and 2, it is necessary to dissolve the polymer particles in a solvent. Once the polymer particles are dissolved, the polymer particles having controlled particle diameters are difficult to form again. This makes it impossible to maintain the polymer particle shapes, which are one of the useful features achieved by an emulsion polymerization.

In view of this, the present invention aims to provide a polymer particle manufacturing method of separating, from polymer particles formed from a polymer having an organotellurium group bonded to its growing end, the organotellurium group while maintaining the particle shapes, thereby obtaining polymer particles having a fully reduced organotellurium group. Further, to achieve such a polymer particle manufacturing method, the present invention also aims to provide a method of obtaining a liquid mixture including polymer particles and an organotellurium compound. Moreover, the present invention also aims to propose a tellurium recovery method according to which tellurium can be recovered from polymer particles formed from a polymer having an organotellurium group bonded to its growing end. Further, the present invention also aims to provide a dispersion of polymer particles having a reduced tellurium concentration and controlled particle shapes, where the polymer particles can be obtained by the above polymer particle manufacturing method.

### Solution to Problem

A polymer particle manufacturing method according to a first aspect of the present invention includes:
(i) mixing a dispersion A of polymer particles A with a reactant, the dispersion A including the polymer particles A and a first solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the first solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the second organotellurium compound is dissolved from each other.

The term “second organotellurium compound” used herein includes every organotellurium compound that can be present in the liquid mixture after the reaction between the reactant and the organotellurium group. Accordingly, the second organotellurium compound also includes, for example, an organotellurium compound present in the liquid mixture as a result of a further reaction of the organotellurium compound, which has been generated by the reaction between the reactant and the organotellurium group.

A polymer particle manufacturing method according to a second aspect of the present invention includes:
(i) mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the reactant being soluble in the solvent; and removing the organotellurium group from the growing end of the polymer to obtain a liquid mixture including an organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the organotellurium compound is dissolved from each other.

According to a method according to a third aspect of the present invention of obtaining a liquid mixture including polymer particles and an organotellurium compound, the following liquid mixture is obtained by mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A.

A tellurium recovery method according to a fourth aspect of the present invention includes:
(I) mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A;
(II) separating, from the liquid mixture, the polymer particles B and a solution in which the second organotellurium compound is dissolved from each other; and
(III) recovering tellurium from the solution, obtained by the step (II), in which the second organotellurium compound is dissolved.

In a dispersion of polymer particles according to a fifth aspect of the present invention,
in the case where a polymer forming the polymer particles is a linear polymer, a molecular weight dispersity is 1 or more and 2 or less, and
in the case where the polymer forming the polymer particles is a branched polymer, the molecular weight dispersity is 1 or more and 4 or less,
a tellurium concentration in the polymer particles is more than 0 mass ppm and 1000 mass ppm or less, and
a polydispersity index of particle diameters of the polymer particles is 0.7 or less.

### Advantageous Effects of Invention

According to the polymer particle manufacturing methods according to the first aspect and the second aspect of the present invention, it is possible to separate, from polymer particles formed from a structurally controlled polymer having an organotellurium group bonded to its growing end, the organotellurium group while maintaining the particle shapes, thereby obtaining polymer particles having a reduced organotellurium group.

According to the method according to the third aspect of the present invention of obtaining a liquid mixture including polymer particles and an organotellurium compound, it is possible to obtain a liquid mixture including polymer particles and organotellurium compound that can achieve the polymer particle manufacturing methods that are the inventions according to the first aspect and the second aspect.

According to the tellurium recovery method according to the fourth aspect of the present invention, it is possible to recover tellurium from polymer particles formed from a polymer having an organotellurium group bonded to its growing end.

According to the dispersion of the polymer particles according to the fifth aspect of the present invention, it is possible to provide a dispersion of polymer particles having a reduced tellurium concentration and controlled particle shapes.

### BRIEF DESCRIPTION OF DRAWINGS

FIG. 1 shows a schematic diagram illustrating an embodiment of a polymer particle manufacturing method according to the present invention.

FIG. 2 shows a ¹H NMR chart of a product obtained in Experimental Example 4 using 2-aminoethanethiol as the reactant.

### DESCRIPTION OF EMBODIMENTS

### First Embodiment

An embodiment of the polymer particle manufacturing method according to the present invention will be described below.

The polymer particle manufacturing method according to the present embodiment includes:
(i) mixing a dispersion A of polymer particles A with a reactant, the dispersion A including the polymer particles A and a first solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the first solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the second organotellurium compound is dissolved from each other.

According to the polymer particle manufacturing method according to the present embodiment, it is possible to separate, from the polymer particles A formed from the structurally controlled polymer synthesized by the emulsion polymerization and having the organotellurium group bonded to the growing end, the organotellurium group while maintaining the particle shapes, thereby obtaining the polymer particles B having the organotellurium group reduced relative to the organotellurium group in the polymer particles A.

For example, in the step (i), it is desirable that the polymer particles B should be obtained by removing the organotellurium group from the growing end of the polymer forming the polymer particles A while maintaining the particle diameters and particle diameter distribution of the polymer particles A. In general, polymer particles formed from a polymer obtained by an emulsion polymerization have a highly controlled particle group shape indicated by, for example, the particle diameters and the polydispersity index of the particle diameters of the particles. According to the manufacturing method according to the present embodiment, it is possible to separate, from the growing end of the polymer forming the polymer particles A, the organotellurium group while substantially maintaining the highly controlled particle group shape of the polymer particles A, thereby obtaining the polymer particles B having the organotellurium group reduced relative to the organotellurium group in the polymer particles A. Therefore, the polymer particles B can be obtained as a particle group having particle diameters with an extremely high homogeneousness. Here, the phrase “the polymer particles B substantially maintain the shapes of the polymer particles A” means that, for example, the rate of change of the average particle diameter of the finally obtained polymer particles B relative to the average particle diameter of the polymer particles A is within ±30%, desirably within ±20%, and more desirably within ±15%, and the rate of change of the polydispersity index of the particle diameters of the finally obtained polymer particles B relative to the polydispersity index of the particle diameters of the polymer particles A is within ±50%, desirably within ±30%.

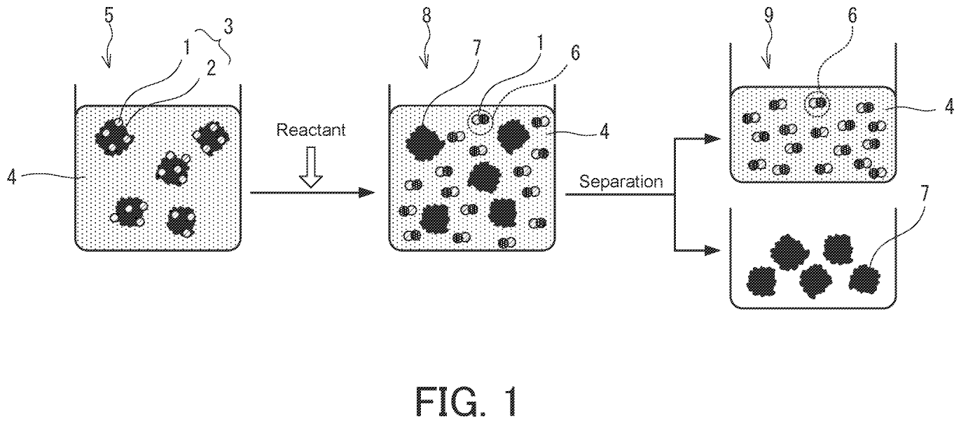

FIG. 1 is a schematic diagram illustrating the polymer particle manufacturing method according to the present embodiment. As shown in FIG. 1, a dispersion 5 (dispersion A) is prepared that includes polymer particles 3 (polymer particles A) formed from a polymer 2 having an organotellurium group 1 at its growing end and a first solvent 4 in which the polymer particles 3 are dispersed. This dispersion 5 is mixed with a reactant soluble in the first solvent 4. The polymer particles 3 are dispersed in the form of particles even after the mixing of the reactant. The reactant and the organotellurium group 1 included in the polymer particles 3 react with each other to generate an organotellurium compound 6 (second organotellurium compound) which is a reaction product. The organotellurium group 1 is separated from the polymer particles 3 and thus polymer particles 7 (polymer particles B) are obtained. Thus, a liquid mixture 8 including the organotellurium compound 6 and the polymer particles 7 is obtained. Next, from the liquid mixture 8, the polymer particles 7 and a solution 9 in which the organotellurium compound 6 is dissolved are separated from each other. In FIG. 1, the polymer particles 7 finally obtained are shown in the form of a solid. However, the polymer particles 7 obtained through the separation step may be in the form of a dispersion in which the polymer particles 7 are dispersed in the solvent. Further, in FIG. 1, all the amount of the organotellurium group 1 is removed from the polymer particles 3 and the polymer particles 7 have no organotellurium group 1. However, the organotellurium group 1 in minute quantities may remain in the polymer particles 7, or an organotellurium compound generated from the separated organotellurium group 1 may be incorporated in minute quantities into the polymer particles 7.

The polymer particle manufacturing method according to the present embodiment may further include (iii) washing the polymer particles B (polymer particles 7 shown in FIG. 1) obtained by the step (ii) with a second solvent, and in the step (iii), the second organotellurium compound may be further separated from the polymer particles B. By including the washing step (iii) in the polymer particle manufacturing method according to the present embodiment, the second organotellurium compound incorporated in minute quantities into the polymer particles B obtained by the separation in the step (ii) is separated from the polymer particles B by the washing in the step (iii). As a result, it is possible to obtain higher-purity polymer particles B into which a further reduced organotellurium compound is incorporated. The tellurium concentration in the polymer particles B is, for example, 1000 mass ppm or less, desirably 500 mass ppm or less, more desirably 100 mass ppm or less, and still more desirably 50 mass ppm or less. Alternatively, the tellurium concentration in the polymer particles B is 70 mass % or less, desirably 60 mass % or less, more desirably 50 mass % or less, still more desirably 20 mass % or less, and particularly desirably 5 mass % or less of the initial tellurium concentration in the polymer particles A.

The steps (i) to (iii) will be described below in more detail.

[Step (i)]

The dispersion A is prepared that includes the polymer particles A and the first solvent in which the polymer particles A are dispersed. The polymer particles A are typically formed from a structurally controlled polymer synthesized by an emulsion polymerization with use of the first organotellurium compound as the polymerization control agent. Accordingly, the first solvent may be the solvent used in the emulsion polymerization. That is, it is also possible to use, as the dispersion A, a dispersion of the polymer particles A obtained by the emulsion polymerization with no modification.

The first organotellurium compound is not particularly limited as long as it can be used as the polymerization control agent in an emulsion polymerization. For example, an organotellurium compound represented by the following general formula (1) can be used as the first organotellurium compound.

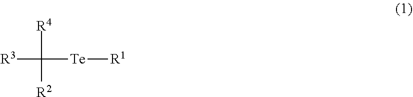

In the above formula (1), R¹ represents an alkyl group having 1 to 12 carbon atoms that may be branched (hereinafter, an alkyl group that may be branched is referred to simply as an “alkyl group”), an aryl group, or an aromatic heterocyclic group. The alkyl group, the aryl group, or the aromatic heterocyclic group, represented by R¹, may have at least one functional group selected from the group consisting of an ether group, a hydroxy group, an amino group, a carboxy group, and a sulfo group.

In the above formula (1), R² and R³ each independently represent a hydrogen atom, an alkyl group having 1 to 12 carbon atoms, an aryl group, an aromatic heterocyclic group, an alkoxy group, an acyl group, an amide group, an oxycarbonyl group, a cyano group, an allyl group, or a propargyl group, and each group may have at least one functional group selected from the group consisting of an ether group, a hydroxy group, an amino group, a carboxy group, and a sulfo group.

R⁴ represents an alkyl group having 1 to 12 carbon atoms, an aryl group, an aromatic heterocyclic group, an alkoxy group, an acyl group, an amide group, an oxycarbonyl group, a cyano group, an allyl group, or a propargyl group, and each group may have at least one functional group selected from the group consisting of an ether group, a hydroxy group, an amino group, a carboxy group, and a sulfo group.

As described above, the group represented by R¹ is an alkyl group having 1 to 12 carbon atoms, an aryl group, or an aromatic heterocyclic group, and is, for example, the following groups.

Examples of the alkyl group having 1 to 12 carbon atoms include: a linear or branched alkyl group such as a methyl group, an ethyl group, an n-propyl group, an isopropyl group, an n-butyl group, an isobutyl group, a sec-butyl group, a tert-butyl group, a pentyl group, a hexyl group, a heptyl group, an octyl group, a nonyl group, a decyl group, an undecyl group, and a dodecyl group; and a cyclic alkyl group such as a cyclohexyl group, and each group may have at least one functional group selected from the group consisting of an ether group, a hydroxy group, an amino group, a carboxy group, and a sulfo group. The alkyl group, which has the at least one functional group selected from the group consisting of an ether group, a hydroxy group, an amino group, a carboxy group, and a sulfo group, only needs to have at least one functional group selected from the group consisting of an ether group, a hydroxy group, an amino group, a carboxy group, and a sulfo group, and the structure thereof is not limited. The ether group and the amino group of the alkyl group may be a polyether group and a polyamino group. One example is a polyethylene glycol group (—(CH₂CH₂O)ₙH). Further, a polyethylene glycol group in which a hydrogen atom at its end is substituted with an alkyl group (—(CH₂CH₂O)ₙR (R: alkyl group)) may be used. Moreover, a polyethylene glycol group in which NH is used instead of O and the end is H(—(CH₂CH₂NH)ₙH) or a polyethylene glycol group in which the end is an alkyl group (—(CH₂CH₂NH)ₙR (R: alkyl group)) may be used.

Examples of the aryl group include a phenyl group and a naphthyl group, and each group may have at least one functional group selected from the group consisting of an ether group, a hydroxy group, an amino group, a carboxy group, and a sulfo group.

Examples of the aromatic heterocyclic group include a pyridyl group, a furyl group, and a thienyl group, and each group may have at least one functional group selected from the group consisting of an ether group, a hydroxy group, an amino group, a carboxy group, and a sulfo group.

The group represented by each of R² to R⁴, namely, an alkyl group having 1 to 12 carbon atoms, an aryl group, a substituted aryl group, an aromatic heterocyclic group, an alkoxy group, an acyl group, an amide group, an oxycarbonyl group, a cyano group, an allyl group, or a propargyl group is, for example, the following groups.

Examples of the alkyl group having 1 to 12 carbon atoms include: a linear or branched alkyl group such as a methyl group, an ethyl group, an n-propyl group, an isopropyl group, an n-butyl group, an isobutyl group, a sec-butyl group, a tert-butyl group, a pentyl group, a hexyl group, a heptyl group, an octyl group, a nonyl group, a decyl group, an undecyl group, and a dodecyl group; and a cyclic alkyl group such as a cyclohexyl group, and each group may have at least one functional group selected from the group consisting of an ether group, a hydroxy group, an amino group, a carboxy group, and a sulfo group.

Examples of the aryl group include a phenyl group and a naphthyl group, and each group may have at least one functional group selected from the group consisting of an ether group, a hydroxy group, an amino group, a carboxy group, and a sulfo group.

Examples of the aromatic heterocyclic group include a pyridyl group, a furyl group, and a thienyl group, and each group may have at least one functional group selected from the group consisting of an ether group, a hydroxy group, an amino group, a carboxy group, and a sulfo group.

The alkoxy group is preferably a group in which an alkyl group having 1 to 12 carbon atoms is bonded to an oxygen atom, and is, for example, a methoxy group, an ethoxy group, a propoxy group, an isopropoxy group, an n-butoxy group, a sec-butoxy group, a tert-butoxy group, a pentyloxy group, a hexyloxy group, a heptyloxy group, an octyloxy group, a nonyloxy group, a decyloxy group, an undecyloxy group, or a dodecyloxy group. Further, each group may have, on its carbon chain, at least one functional group selected from the group consisting of an ether group, a hydroxy group, an amino group, a carboxy group, and a sulfo group.

The acyl group is an acetyl group, a propionyl group, a benzoyl group, or the like. Further, each group may have, on its carbon chain, at least one functional group selected from the group consisting of an ether group, a hydroxy group, an amino group, a carboxy group, and a sulfo group.

The amide group is —CONR⁴¹R⁴² (where R⁴¹ and R⁴² each independently represent a hydrogen atom, an alkyl group having 1 to 8 carbon atoms, or an aryl group). Further, each group may have, on its carbon chain, at least one functional group selected from the group consisting of an ether group, a hydroxy group, an amino group, a carboxy group, and a sulfo group.

The oxycarbonyl group is preferably a group represented by —COOR⁴³ (where R⁴³ represents a hydrogen atom, an alkyl group having 1 to 12 carbon atoms, or an aryl group), and is, for example, a carboxy group, a methoxycarbonyl group, an ethoxycarbonyl group, a propyloxycarbonyl group, an n-butoxycarbonyl group, a sec-butoxycarbonyl group, a ter-butoxycarbonyl group, an n-pentoxycarbonyl group, or a phenoxycarbonyl group. Further, each group may have, on its carbon chain, at least one functional group selected from the group consisting of an ether group, a hydroxy group, an amino group, a carboxy group, and a sulfo group. The oxycarbonyl group may be a salt of a carboxy group.

The allyl group is —CR⁴⁴R⁴⁵—CR⁴⁶═CR⁴⁷R⁴⁸ (where R⁴⁴ and R⁴⁵ each independently represent a hydrogen atom or an alkyl group having 1 to 12 carbon atoms, R⁴⁶, R⁴⁷, and R⁴⁸ each independently represent a hydrogen atom, an alkyl group having 1 to 12 carbon atoms, or an aryl group, and their respective substituents may be linked by a ring structure) or the like. Further, each group may have, on its carbon chain, at least one functional group selected from the group consisting of an ether group, a hydroxy group, an amino group, a carboxy group, and a sulfo group.

The propargyl group is —CR⁴⁹R⁵⁰—C≡CR⁵¹ (where R⁴⁹ and R⁵⁰ each represent a hydrogen atom or an alkyl group having 1 to 12 carbon atoms, and R⁵¹ represents a hydrogen atom, an alkyl group having 1 to 12 carbon atoms, an aryl group, or a silyl group) or the like. Further, each group may have, on its carbon chain, at least one functional group selected from the group consisting of an ether group, a hydroxy group, an amino group, a carboxy group, and a sulfo group.

The first organotellurium compound to be used as the polymerization control agent in an emulsion polymerization may be appropriately selected according to, for example, the type of polymer to be synthesized by the emulsion polymerization, and is not particularly limited. In the case where the solvent to be used in the emulsion polymerization is the first solvent, a compound soluble in the first solvent is used as the first organotellurium compound. At this time, for an oil-in-water emulsion polymerization using water as the first solvent, the first organotellurium compound preferably has a highly hydrophilic group, whereas for a water-in-oil emulsion polymerization using an organic solvent as the first solvent, the first organotellurium compound preferably has a highly hydrophobic group.

The first solvent may be any solvent in which the polymer particles A are indissoluble and the reactant is dissoluble. For example, the first solvent can be selected as desired according to the conditions of an oil-in-water emulsion polymerization using water as the first solvent, a water-in-oil emulsion polymerization using an organic solvent as the first solvent, and the like.

The reactant is not particularly limited as long as it is a compound that is soluble in the first solvent and can efficiently react with an organotellurium group. The phrase “a reactant is soluble in a solvent” used herein means that the reactant only needs to be dissolved to the extent that the reactant can react as the solute, and is not necessarily completely dissolved. The reactant preferably has, for example, a first substituent reactive with the organotellurium group included in the growing end of the polymer particles A and at least one second substituent having an affinity for the first solvent. The second substituent preferably has a higher affinity for the first solvent. By having such first substituent and second substituent, the reactant is soluble in the first solvent and can react with the organotellurium group included in the growing end of the polymer particles A to cleave the organotellurium group from the polymer.

The reactant may be, for example, a reductant. Examples of the first substituent reactive with tellurium include a thiol group, a selenol group, and a tellurol group.

For example, in the case where the first solvent includes water, the second substituent is preferably at least one selected from the group consisting of a carboxy group, a salt of a carboxy group, an amino group, a salt of an amino group, an amide group, a hydroxy group, a sulfo group, a salt of a sulfo group, and an ether group. By having such a second substituent, the reactant is easily dissolved in the first solvent including water and can efficiently react with the organotellurium group included in the growing end of the polymer particles A.

A thiol may be represented by, for example, the following formula (2).

R⁵—S—H (2)

In the above formula (2), R⁵ represents: an aryl group having at least one functional group selected from the group consisting of a carboxy group, a salt of a carboxy group, a hydroxy group, an amino group, a salt of an amino group, an amide group, a sulfo group, a salt of a sulfo group, and an ether group; or an alkyl group having 1 to 12 carbon atoms (preferably 1 to 8 carbon atoms, more preferably 1 to 6 carbon atoms) and having at least one functional group selected from the group consisting of a carboxy group, a salt of a carboxy group, a hydroxy group, an amino group, a salt of an amino group, an amide group, a sulfo group, a salt of a sulfo group, and an ether group. The aryl group represented by R⁵, which has the at least one functional group selected from the group consisting of a carboxy group, a salt of a carboxy group, a hydroxy group, an amino group, a salt of an amino group, an amide group, a sulfo group, a salt of a sulfo group, and an ether group, only needs to have at least one functional group selected from the group consisting of a carboxy group, a salt of a carboxy group, a hydroxy group, an amino group, a salt of an amino group, an amide group, a sulfo group, a salt of a sulfo group, and an ether group, and the structure thereof is not limited. Examples of the thiol having the aryl group as R⁵ include p-mercaptobenzoic acid, m-mercaptobenzoic acid, and o-mercaptobenzoic acid. The alkyl group represented by R⁵, which has the at least one functional group selected from the group consisting of an ether group, a carboxy group, and a salt of a carboxy group, a hydroxy group, an amino group, a salt of an amino group, an amide group, a sulfo group, and a salt of a sulfo group, only needs to have at least one functional group selected from the group consisting of an ether group, a carboxy group, and a salt of a carboxy group, a hydroxy group, an amino group, a salt of an amino group, an amide group, a sulfo group, and a salt of a sulfo group, and the structure thereof is not limited. The ether group and the amino group of the alkyl group may be a polyether group and a polyamino group. One example is a polyethylene glycol group (—(CH₂CH₂O)ₙH). Further, a polyethylene glycol group in which a hydrogen atom at its end is substituted with an alkyl group (—(CH₂CH₂O)ₙR (R: alkyl group)) may be used. Moreover, a polyethylene glycol group in which NH is used instead of O and the end is H(—(CH₂CH₂NH)ₙH) or a polyethylene glycol group in which the end is an alkyl group (—(CH₂CH₂NH)ₙR (R: alkyl group)) may be used. This thiol is suitable for the case where the first solvent includes water.

A tellurol may be represented by, for example, the following formula (3).

R⁶—Te—H (3)

In the above formula (3), R⁶ represents: an aryl group having at least one functional group selected from the group consisting of a carboxy group, a salt of a carboxy group, a hydroxy group, an amino group, a salt of an amino group, an amide group, a sulfo group, a salt of a sulfo group, and an ether group; or an alkyl group having 1 to 12 carbon atoms (preferably 1 to 8 carbon atoms, more preferably 1 to 6 carbon atoms) and having at least one functional group selected from the group consisting of a carboxy group, a salt of a carboxy group, a hydroxy group, an amino group, a salt of an amino group, an amide group, a sulfo group, a salt of a sulfo group, and an ether group. The aryl group represented by R⁶, which has the at least one functional group selected from the group consisting of a carboxy group, a salt of a carboxy group, a hydroxy group, an amino group, a salt of an amino group, an amide group, a sulfo group, a salt of a sulfo group, and an ether group, only needs to have at least one functional group selected from the group consisting of a carboxy group, a salt of a carboxy group, a hydroxy group, an amino group, a salt of an amino group, an amide group, a sulfo group, a salt of a sulfo group, and an ether group, and the structure thereof is not limited. The alkyl group represented by R⁶, which has the at least one functional group selected from the group consisting of an ether group, a carboxy group, and a salt of a carboxy group, a hydroxy group, an amino group, a salt of an amino group, an amide group, a sulfo group, and a salt of a sulfo group, only needs to have at least one functional group selected from the group consisting of an ether group, a carboxy group, and a salt of a carboxy group, a hydroxy group, an amino group, a salt of an amino group, an amide group, a sulfo group, and a salt of a sulfo group, and the structure thereof is not limited. The ether group and the amino group of the alkyl group may be a polyether group and a polyamino group. One example is a polyethylene glycol group (—(CH₂CH₂O)ₙH). Further, a polyethylene glycol group in which a hydrogen atom at its end is substituted with an alkyl group (—(CH₂CH₂O)ₙR (R: alkyl group)) may be used. Moreover, a polyethylene glycol group in which NH is used instead of O and the end is H(—(CH₂CH₂NH)ₙH) or a polyethylene glycol group in which the end is an alkyl group (—(CH₂CH₂NH)ₙR (R: alkyl group)) may be used. This tellurol is suitable for the case where the first solvent includes water.

In the case where the first solvent includes water, a selenol may be represented by, for example, the following formula (4).

R⁷—Se—H (4)

In the above formula (4), R⁷ represents: an aryl group having at least one functional group selected from the group consisting of a carboxy group, a salt of a carboxy group, a hydroxy group, an amino group, a salt of an amino group, an amide group, a sulfo group, a salt of a sulfo group, and an ether group; or an alkyl group having 1 to 12 carbon atoms (preferably 1 to 8 carbon atoms, more preferably 1 to 6 carbon atoms) and having at least one functional group selected from the group consisting of a carboxy group, a salt of a carboxy group, a hydroxy group, an amino group, a salt of an amino group, an amide group, a sulfo group, a salt of a sulfo group, and an ether group. The aryl group represented by R⁷, which has the at least one functional group selected from the group consisting of a carboxy group, a salt of a carboxy group, a hydroxy group, an amino group, a salt of an amino group, an amide group, a sulfo group, a salt of a sulfo group, and an ether group, only needs to have at least one functional group selected from the group consisting of a carboxy group, a salt of a carboxy group, a hydroxy group, an amino group, a salt of an amino group, an amide group, a sulfo group, a salt of a sulfo group, and an ether group, and the structure thereof is not limited. The alkyl group represented by R⁷, which has the at least one functional group selected from the group consisting of an ether group, a carboxy group, and a salt of a carboxy group, a hydroxy group, an amino group, a salt of an amino group, an amide group, a sulfo group, and a salt of a sulfo group, only needs to have at least one functional group selected from the group consisting of an ether group, a carboxy group, and a salt of a carboxy group, a hydroxy group, an amino group, a salt of an amino group, an amide group, a sulfo group, and a salt of a sulfo group, and the structure thereof is not limited. The ether group and the amino group of the alkyl group may be a polyether group and a polyamino group. One example is a polyethylene glycol group (—(CH₂CH₂O)ₙH). Further, a polyethylene glycol group in which a hydrogen atom at its end is substituted with an alkyl group (—(CH₂CH₂O)ₙR (R: alkyl group)) may be used. Moreover, a polyethylene glycol group in which NH is used instead of O and the end is H(—(CH₂CH₂NH)ₙH) or a polyethylene glycol group in which the end is an alkyl group (—(CH₂CH₂NH)ₙR (R: alkyl group)) may be used. This selenol is suitable for the case where the first solvent includes water.

The amount of the reactant to be mixed with the dispersion A of the polymer particles A can be determined in consideration of the amount of the organotellurium group included in the growing end of the polymer forming the polymer particles A. For example, the reactant may be mixed so as to have an amount of 1.0 to 10.0 mol relative to 1 mol of the organotellurium group included in the growing end of the polymer included in the dispersion A of the polymer particles A. Preferably, the reactant should be mixed so as to have an amount of 1.0 to 2.0 mol relative to 1 mol of this organotellurium group.

After the reaction between the reactant and the organotellurium group 1 included in the polymer particles 3 generates the organotellurium compound 6 (second organotellurium compound), which is a reaction product, a suitable reactant that is reactive with the second substituent derived from the reactant may be further added to increase the solubility of the organotellurium compound 6 in the first solvent. This efficiently separates the reactant and the organotellurium group from each other. For example, for the first solvent being water, a base such as sodium hydroxide may be added to the liquid mixture when the second substituent derived from the reactant is a carboxy group, whereas an acid such as hydrochloric acid may be added to the liquid mixture when the second substituent derived from the reactant is an amino group. In this example, addition of a base or an acid causes a reaction a reaction with the second substituent derived from the reactant to generate a salt, so that the hydrophilicity of the reactant is enhanced.

The reaction temperature and reaction time for reacting the organotellurium group at the growing end of the polymer with the reactant can be appropriately adjusted according to the organotellurium group and the reactant to be used, and are not particularly limited. In an example, the reaction is performed, for example, at a reaction temperature in the range of 0° C. to 100° C. and for a reaction time in the range of 0.1 to 24 hours while stirring the liquid mixture. To promote the reaction, light irradiation may be performed.

The step (i) in the polymer particle manufacturing method according to the present embodiment can be regarded as a “method of obtaining a liquid mixture including polymer particles and an organotellurium compound”. That is, the step (i) can be reworded as “a method of obtaining a liquid mixture including polymer particles and an organotellurium compound, the method including mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A”. The details of this method of obtaining a liquid mixture including polymer particles and an organotellurium compound are the same as the above detailed description of the step (i), and accordingly the description thereof will be omitted here.

[Step (ii)]

From the liquid mixture, which is obtained by the step (i) and includes the second organotellurium compound generated by the reaction between the reactant and the organotellurium group and the polymer particles B having the organotellurium group reduced relative to the organotellurium group in the polymer particles A, the polymer particles B and a solution in which the second organotellurium compound is dissolved are separated from each other. In this step (ii), for example, a solid-liquid separation method can be used for separating, from the liquid mixture, the polymer particles B and the solution in which the second organotellurium compound is dissolved from each other, although any method enabling the separation is available.

As the solid-liquid separation method to be used in the polymer particle manufacturing method according to the present embodiment, a known solid-liquid separation method is applicable. Accordingly, a suitable method can be appropriately selected from among known solid-liquid separation methods in consideration of, for example, the particle diameter of the polymer particles B. For example, a centrifugal sedimentation separation method or a filtration method can be used. The filtration method includes a pressure filtration method of applying a pressure to the liquid, a suction (vacuum) filtration method, a centrifugal filtration method, and the like, and further includes a cross-flow filtration method, a dead-end filtration method, and the like differing in direction in which the liquid flows relative to the membrane. Any of the methods can be used. Particularly preferred among these are the centrifugal filtration method and the cross-flow filtration method according to which, from the liquid mixture, the polymer particles or the solution in which the polymer particles are dispersed and the solution in which the second organotellurium compound is dissolved can be separated from each other in a short time. The filter medium to be used is not particularly limited, and a suitable filter medium can be selected from among known filter media in consideration of, for example, the particle diameter of the polymer particles B.

In the step (ii), in separating the polymer particles B and the solution in which the second organotellurium compound is dissolved from each other, a solvent may be added as the diluent to the liquid mixture, for example. The solvent to be used as the diluent is preferably a solvent that has an affinity for the first solvent and in which the polymer particles B are indissoluble. For example, in the case where the first solvent includes water, the solvent to be used as the diluent in the step (ii) is preferably a solvent that is indefinitely dilutable with water and in which the polymer particles B are indissoluble. Examples of such a solvent include one solvent or a solvent mixture of two or more solvents selected from the group consisting of, for example, water, an alcohol, an amide, a ketone, and an alkyl sulfoxide.

The polymer particles B to be obtained by the step (ii) may be in the form of a dispersion B in which the polymer B is dispersed in, for example, the first solvent or a solvent mixture including a solvent added as the diluent in the separation step and the first solvent.

[Step (iii)]

As described above, the polymer particle manufacturing method according to the present embodiment may further include the step (iii) of washing the polymer particles B obtained by the step (ii) with the second solvent. The second solvent to be used in this washing step is a solvent that has an affinity for the first solvent and in which the polymer particles B are indissoluble. The solvent in which the polymer particles B are indissoluble may be any solvent in which the polymer particles B are indissoluble to such an extent that, in the case where the solvent is mixed with the polymer particles B, the rate of change of the average particle diameter of the polymer particles B does not vary by ±30% or more and the rate of change of the polydispersity index of the average particle diameter of the polymer particles B does not vary by ±50% or more.

In the case where the first solvent includes water, the second solvent is preferably a solvent that is indefinitely dilutable with water and in which the polymer particles B are indissoluble. In this case, the second solvent preferably includes one solvent or a solvent mixture of two or more solvents selected from the group consisting of water, an alcohol, an amide, a ketone, and an alkyl sulfoxide. By washing the polymer particles B with such a second solvent, the organotellurium compound can be further reduced from the solution in which the polymer particles B are dispersed.

The washing step (iii) may be repeated multiple times. In this case, a solvent of the same type may be used as the second solvent each time, or solvents of multiple types may be used as the second solvent. For example, both washing with water as the second solvent and washing with an alcohol, such as methanol, as the second solvent may be performed. Thus, by washing the polymer particles B with the second solvents of different types, the organotellurium compound can be further reduced from the solution in which the polymer particles are dispersed, and the purity of the resultant polymer particles B can be further enhanced in some cases.

According to the polymer particle manufacturing method according to the present embodiment, the finally obtained polymer particles B can be reduced in terms of tellurium concentration relative to the polymer particles A. The tellurium concentration in the polymer particles B can be set to 70 mass % or less, desirably 60 mass % or less, more desirably 50 mass % or less, still more desirably 20 mass % or less, and particularly desirably 5 mass % or less of the initial tellurium concentration in the polymer particles A. Thus, the tellurium concentration in the polymer particles B can be set to 1000 mass ppm or less, desirably 500 mass ppm or less, and still more desirably 50 mass ppm or less.

In the present embodiment, the description has been given on, as the polymer particle manufacturing method, the method of separating the organotellurium group from the polymer particles A formed from the structurally controlled polymer having the organotellurium group at the growing end, where the polymer is synthesized by an emulsion polymerization with use of the first organotellurium compound as the polymerization control agent. However, the method according to the present invention of separating, from a polymer, an organotellurium group included at the growing end of the polymer is not a method that can be performed only for a polymer synthesized by an emulsion polymerization, but is also applicable as a method of separating, from a polymer, an organotellurium group included at the growing end of the polymer irrespective of the polymer polymerization process.

That is, the polymer particle manufacturing method according to the present invention may be, as another aspect thereof, a polymer particle manufacturing method including:
(i) mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the reactant being soluble in the solvent; and removing the organotellurium group from the growing end of the polymer to obtain a liquid mixture including an organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the organotellurium compound is dissolved from each other.

The type of polymer obtained by the polymer particle manufacturing method according to the present embodiment is typically a polymer that can be synthesized by an emulsion polymerization, but is not limited to this. The polymer particle manufacturing method according to the present embodiment is applicable to, for example, a suspension polymerization and a dispersion polymerization as well.

### Second Embodiment

An embodiment of the tellurium recovery method according to the present invention will be described below.

The tellurium recovery method according to the present embodiment includes:
(I) mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A;
(II) separating, from the liquid mixture, the polymer particles B and a solution in which the second organotellurium compound is dissolved from each other; and
(III) recovering tellurium from the solution, obtained by the step (II), in which the second organotellurium compound is dissolved.

In the tellurium recovery method according to the present embodiment, the above steps (I) and (II) are respectively the same as the steps (i) and (ii) in the polymer particle manufacturing method described in the first embodiment, and accordingly the detailed description thereof will be omitted here.

The tellurium recovery method according to the present embodiment further includes the step (III) of recovering tellurium from the solution, obtained by the step (II), in which the second organotellurium compound is dissolved. As the method of recovering tellurium from the solution, a known method of recovering tellurium from a solution can be appropriately selected and used. According to an exemplary method, an inorganic iodine compound is added to a solution in which the second organotellurium compound is dissolved, a sulfur oxide is further supplied to precipitate tellurium contained in the solution, and then solid-liquid separation is performed to recover tellurium.

### Third Embodiment

An embodiment of the dispersion of polymer particles according to the present invention will be described below.

The dispersion of the polymer particles according to the present embodiment is a dispersion of polymer particles in which a tellurium concentration is reduced as compared with polymer particles formed from a polymer immediately after synthesis by, for example, subjecting polymer particles formed from a structurally controlled polymer and synthesized by an emulsion polymerization with use of an organotellurium compound as the polymerization control agent to a treatment for separating an organotellurium group contained in a growing end of the polymer. In the dispersion of the polymer particles according to the present embodiment, the tellurium concentration in the polymer particles is more than 0 mass ppm and 1000 mass ppm or less, desirably 500 mass ppm or less, and more desirably 50 mass ppm or less. In the present embodiment, it is also possible to achieve polymer particles having a tellurium concentration reduced to 10 mass ppm or less. When the tellurium concentration in the polymer particles in the dispersion according to the present embodiment is expressed as the ratio relative to the tellurium concentration in the polymer particles before the treatment for separating the organotellurium group included in the growing end of the polymer (initial tellurium concentration), the tellurium concentration in the polymer particles in the dispersion according to the present embodiment is 70 mass % or less, desirably 60 mass % or less, more desirably 50 mass % or less, still more desirably 20 mass % or less, and particularly more desirably 5 mass % or less of the initial tellurium concentration in the polymer particles.

In the dispersion of the polymer particles according to the present embodiment, the polydispersity index of the particle diameters of the polymer particles is 0.7 or less, desirably 0.5 or less.

In the dispersion of the polymer particles finally obtained in the present embodiment, the polydispersity index of the particle diameters of the polymer particles is controlled to 0.7 or less and the tellurium concentration in the polymer particles is as extremely low as 1000 mass ppm or less. The dispersion of the polymer particles having the polydispersity index of the particle diameters controlled in such a range usually seems to be a dispersion of polymer particles formed from a polymer obtained through a synthetization by the manufacturing method described in the first embodiment. In the dispersion of the polymer particles finally obtained in the present embodiment, the concentration of the organotellurium compound is extremely low in spite of the particle diameters that are controlled to narrowly disperse. Therefore, the dispersion of the polymer particles according to the present embodiment is an extremely useful dispersion of polymer particles with a highly controlled polydispersity index of the particle diameters and an extremely low concentration of an organotellurium compound, which cannot be achieved by conventional methods.

In the dispersion of the polymer particles finally obtained in the present embodiment, the polymer particles have an average particle diameter of, for example, 1 nm or more and 100 μm or less, desirably 1 μm or less. Thus, in the dispersion of the polymer particles finally obtained in the present embodiment, the average particle diameter of the polymer particles can be set to 1 nm or more and 100 μm or less. Therefore, the dispersion of the polymer particles according to the present embodiment is an extremely useful dispersion of polymer particles with a controlled average particle diameter and an extremely low concentration of an organotellurium compound, which cannot be achieved by conventional methods.

In the present specification, the polydispersity index of the particle diameters and average particle diameter of the polymer particles are determined by a photon correlation method employing dynamic light scattering. This measurement can be performed with a measurement device described later.

In the case where the polymer forming the dispersion of the polymer particles according to the present embodiment described herein is a linear polymer, the molecular weight dispersity satisfies 1 or more and 2 or less, more preferably 1 or more and 1.5 or less. In the case where the polymer forming the dispersion of the polymer particles according to the present embodiment is a branched polymer, the molecular weight dispersity satisfies 1 or more and 4 or less, more preferably 1 or more and 2 or less. The polymer forming the dispersion of the polymer particles according to the present embodiment is preferably a polymer having molecular weight dispersity exhibiting a monodispersity. Further, the polymer forming the dispersion of the polymer particles according to the present embodiment is preferably a polymer having a molecular weight dispersity exhibiting unimodality. Here, the molecular weight dispersity is the value determined by the ratio of the weight-average molecular weight M_{w} to the number-average molecular weight Mₙ, M_{w}/Mₙ, and represents the molecular weight distribution. A polymer having a molecular weight dispersity that satisfies the above range is a polymer having an extremely uniform molecular weight. Therefore, the dispersion of the polymer particles formed from the polymer having the dispersity that satisfies the above range is applicable to various purposes and extremely useful owing to the uniform molecular weight.

The polymer forming the polymer particles according to the present embodiment is not particularly limited as long as it is a polymer that can be synthesized by an emulsion polymerization using the TERP process. Examples of the polymer include polymers differing in composition such as a homopolymer, a random copolymer, a sequence-controlled copolymer, and a block copolymer and polymers differing in structure such as a polymer having a linear structure and a polymer having a branched structure. Although the molecular weight is also not limited because it depends on the purpose. However, the polymer forming the polymer particles according to the present embodiment is characterized in having a molecular weight distribution exhibiting unimodality.

### EXAMPLES

The present invention will be described below in more detail with reference to examples. However, the present invention is not limited to the following examples.

<Examination of Reactant>

First, the reactant to be used for separating the organotellurium group from the growing end of the polymer was examined. Specifically, as for the thiol represented by the above formula (2), the following model experiment was performed to demonstrate how the structure of the thiol for use in reducing the growing end of the polymer is related to the reactivity and to check whether to enable the molecule of an organotellurium compound (corresponding to the second organotellurium compound) generated by the reduction to be water-soluble.

The model small molecule used for generating an acrylate radical was an organotellurium compound that can be used as the polymerization control agent in a polymer polymerization according to the present invention (corresponding to the first organotellurium compound). A specific example used was an organotellurium compound represented by the following formula (5).

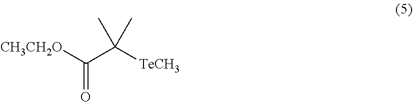

To enhance the water solubility of the organotellurium compound, which is a product, thiols each having a carboxy group and a thiol having an amino group were selected as examples of the reactant. The thiols each having a carboxy group used were o-mercaptobenzoic acid represented by the following formula (6) (Experimental Example 1), m-mercaptobenzoic acid represented by the following formula (7) (Experimental Example 2), and p-mercaptobenzoic acid represented by the following formula (8) (Experimental Example 3). The thiol having an amino group used was 2-aminoethanethiol (HSCH₂CH₂NH₂) (Experimental Example 4).

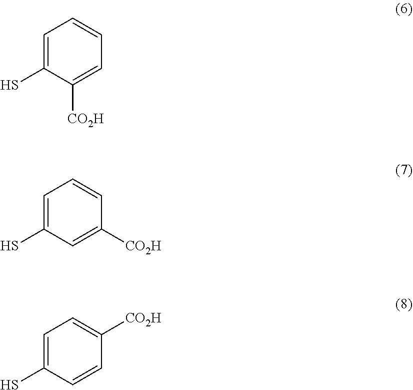 [SMILES: O=C(O)c1ccccc1S ; O=C(O)c1cccc(S)c1 ; O=C(O)c1ccc(S)cc1]

The organotellurium compound represented by the above formula (5) and the mercaptobenzoic acid (1.3 equivalents) represented by any one of the above formulas (6) to (8) were dissolved in dimethyl sulfoxide-D6 (DMSO-d₆). Then, a reduction was performed under light irradiation conditions at 65° C. with a 6-W white light emitting diode (LED) lamp until the conversion rate of the organotellurium compound reached 100%. o-Mercaptobenzoic acid represented by the above formula (6) was completely consumed beyond the equivalence relation, whereas the other thiols (m-mercaptobenzoic acid and p-mercaptobenzoic acid) were consumed in the equivalence relation with the organotellurium compound.

The products that can be generated by the reaction of the above organotellurium compound with each of the mercaptobenzoic acids and 2-aminoethanethiol are an ester compound represented by the following formula (9) (Product 1), a reduced product represented by the following formula (10) (Product 2), a ditelluride represented by the following formula (11) (Product 3), and a compound represented by the following formula (12) (Product 4).

(CH₃)₂CHCOOC₂H₅ (9)

RS—TeCH₃ (10)

(TeCH₃)₂ (11)

RSSR (12)

Here, in the above formulas (10) and (12), R represents 2-carboxyphenyl group (Experimental Example 1), 3-carboxyphenyl group (Experimental Example 2), 4-carboxyphenyl group (Experimental Example 3), or 2-aminoethyl group (Experimental Example 4).

The following Table 1 shows the yields of Products 1 to 4 in Experimental Examples 1 to 4.

TABLE 1

| | | Yield (%) | | | |
|---|---|---|---|---|---|
| | | Product 1 | Product 2 | Product 3 | Product 4 |
| | Reactant | (CH₃)₂CHCOOC₂H₅ | RS-TeCH₃ | (TeCH₃)₂ | RSSR |
| Experimental | o-Mercaptobenzoic | 85 | 23 | 82 | 100 |
| Example 1 | acid | | | | |
| Experimental | m-Mercaptobenzoic | 84 | 81 | 16 | 0 |
| Example 2 | acid | | | | |
| Experimental | p-Mercaptobenzoic | 90 | >99 | <1 | 0 |
| Example 3 | acid | | | | |
| Experimental | 2-Aminoethanethiol | 95 | 0 | 86 | 80 |
| Example 4 | | | | | |

In Experimental Examples 1 and 2 in which o-mercaptobenzoic acid and m-mercaptobenzoic acid were respectively used as the reactants, the yield of the generated ester compound (Product 1) was about 85%, demonstrating that these reactants have a high reduction efficiency. The ditelluride (Product 3) generated here was water-insoluble. The production of the ditelluride (Product 3) demonstrates that the reduced product (Product 2) is unstable and gradually decomposes into the ditelluride (Product 3) and the compound represented by the formula (12) (Product 4). In Experimental Example 3 in which p-mercaptobenzoic acid having a carboxy group in the para position was used, the ester compound (Product 1) was obtained in a high yield, and furthermore the yield of the reduced product (Product 2) was 90% or more as well. The results indicate that the reduced product (Product 2) is stable. Accordingly, using p-mercaptobenzoic acid as the reactant seems to be advantageous in terms of recovering the tellurium compound separated from the polymer through the reduction reaction.

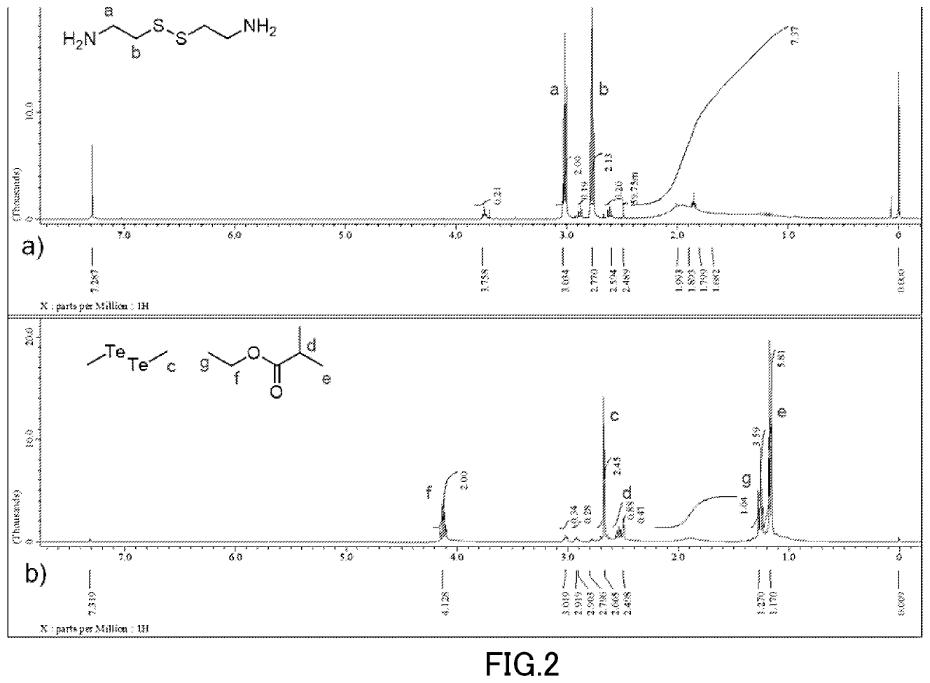

From the peak of the TeMe group in ¹H NMR, it is confirmed that the use of 2-aminoethanethiol having an amino group as the reactant (Experimental Example 4) completes the reaction immediately after mixing into the solvent together with the organotellurium compound represented by the above formula (5). The yield of the ester compound (Product 1) was 95%. On the other hand, the peak of the reduced product (Product 2) disappeared in less than 10 minutes, and the peaks of the ditelluride (Product 3) and the compound represented by the formula (12) (Product 4) were observed. These two compounds were each extracted by the post-treatment, and their structures were determined by ¹H NMR using CDCl₃ as the solvent (see FIG. 2). The results mean that the reduced product (Product 2) generated from the thiol having an amino group is unstable and spontaneously decomposes to generate the ditelluride (Product 3). In the case where the organotellurium compound represented by the above formula (5) is used, a hydrophobic ditelluride is generated. However, by using an organotellurium compound in which a hydrophilic substituent is bonded to tellurium, it is possible to directly obtain a ditelluride that can be separated and recovered as a water-soluble compound, promising to be an effective method for tellurium recycle.

### EXAMPLES

### Example 1

[Polymer Synthesis by Emulsion Polymerization]

Under a nitrogen atmosphere, a polymerization control agent (1.5 mg, 5.0 μmol) and hexadecyltrimethylammonium bromide (CTAB, 260 mg, 4.3 mass % relative to water) were added to a glass tube. The polymerization control agent used was an organotellurium compound represented by the following formula (13).

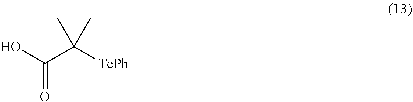

To the above glass tube, degassed and deionized water (6.0 mL) and an aqueous sodium hydroxide solution (10 μL, 0.51 molL⁻¹, 5.0 μmol) were further added to obtain a homogeneous solution. This solution was mixed with styrene (0.58 mL, 5.0 mmol) as a monomer to obtain a mixture. The mixture thus obtained was heated at 80° C. for 6 hours while stirring the mixture under a 6-W white light emitting diode (LED) lamp. The reaction mixture was periodically removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of styrene reached 90% 6 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed by the size exclusion chromatography (SEC). The results indicated that a polystyrene having a number-average molecular weight Mₙ=91,200 and a molecular weight dispersity=1.26 had been generated. Further, another portion (approximately 10 μL) of the dispersion was diluted with deionized water (approximately 5.0 mL) to produce a sample for polymer particle measurement. The average particle diameter and polydispersity index of the particle diameters of polymer particles in this sample were measured with a light scattering apparatus (ELSZ-1000ZSY, manufactured by Otsuka Electronics Co., Ltd.). The results were that the polymer particles had an average particle diameter of 200.4 nm and a polydispersity index of the particle diameters of 0.50.

Table 2 shows the measurement results of the above physical properties on the polymer particles formed from the polymer synthesized in the present example.

[Separation of Organotellurium Group from Growing End of Polymer]

As the reactant soluble in water which is the first solvent, p-mercaptobenzoic acid represented by the above formula (8) was used.

This p-mercaptobenzoic acid (7.5 μmol) and an aqueous sodium hydroxide solution (15 μL, 0.51 molL⁻¹, 7.5 μmol) were dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 52 mL), and the resultant liquid mixture was transferred to a plastic container (Jumbosep, manufactured by Pall Corporation) equipped with a membrane filter for centrifugal filtration (Membrane Inserts 300K, manufactured by Pall Corporation). This container was set in a centrifuge (VIOLAMO 444315-100, manufactured by AS ONE Corporation), and the liquid mixture was centrifuged and filtered at G=1,500. This concentrated the liquid mixture to approximately 8 mL. That is, the above centrifugal filtration resulted in a concentrated liquid mixture including the polymer particles and an aqueous solution separated from this liquid mixture.

Next, a process was performed to wash the polymer particles included in the liquid mixture, which had been concentrated to approximately 8 mL. Specifically, the concentrated liquid mixture (8 mL) was first increased in volume to 60 mL by adding degassed and deionized water (approximately 52 mL), and this liquid mixture thus obtained was concentrated to approximately 8 mL by a centrifugal filtration method similar to the above. This procedure was repeated twice. Next, the concentrated liquid mixture (8 mL) was increased in volume to 60 mL by adding degassed methanol (approximately 52 mL), and the resultant liquid mixture was concentrated to approximately 8 mL by a centrifugal filtration method similar to the above. This procedure was repeated twice.

The aqueous solution and the methanol solution separated by the n-th time centrifugal filtration are respectively expressed as an aqueous solution n and a methanol solution n. That is, the aqueous solution separated by the 1st time centrifugal filtration is expressed as an aqueous solution 1. The tellurium concentrations in the aqueous solution 1, an aqueous solution 2, an aqueous solution 3, a methanol solution 4, and a methanol solution 5 (total of five samples), each of which had been separated, were measured by ICP-AES described later. The tellurium recovery rate determined from the results was 96.3%. Further, the concentrated liquid mixture finally obtained was freeze-dried to obtain a polymer sample. The residual tellurium concentration in the obtained polymer sample was determined to 47.4 ppm (residual rate of 3.7%). The residual tellurium rate was determined by using the theoretical initial tellurium concentration of 1,280 ppm. Table 3 shows the tellurium recovery rate and the residual concentration and residual rate of tellurium in the polymer sample.

### Example 2

[Polymer Synthesis by Emulsion Polymerization]

Under a nitrogen atmosphere, a polymerization control agent (1.6 mg, 5.0 μmol) and CTAB (260 mg, 4.3 mass % relative to water) were added to a glass tube. The polymerization control agent used was an organotellurium compound represented by the following formula (14).

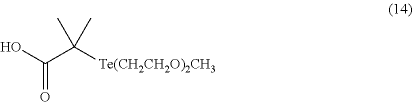

To the above glass tube, degassed and deionized water (6.0 mL) and an aqueous sodium hydroxide solution (10 μL, 0.51 molL⁻¹, 5.0 μmol) were further added to obtain a homogeneous solution. This solution was mixed with styrene (0.58 mL, 5.0 mmol) as a monomer to obtain a mixture. The mixture thus obtained was heated at 80° C. for 3 hours while stirring the mixture under a 6-W white light emitting diode (LED) lamp. Subsequently, the reaction mixture was removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of styrene reached 95% 3 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed for the number-average molecular weight Mₙ and the molecular weight dispersity by SEC as in Example 1. Further, another portion (approximately 10 μL) of the dispersion was diluted with deionized water (approximately 5.0 mL) to produce a sample for polymer particle measurement. This sample was used to measure the average particle diameter and the polydispersity index of the particle diameters of the polymer particles with a light scattering apparatus similar to that in Example 1. As for the polymer synthesized in Example 2, Table 2 shows the number-average molecular weight Mₙ, the molecular weight dispersity, the average particle diameter, and the polydispersity index of the particle diameters.

[Separation of Organotellurium Group from Growing End of Polymer]

As the reactant soluble in water which is the first solvent, p-mercaptobenzoic acid used in Example 1 was used. This thiol (7.5 μmol) was dissolved in 2.0-mL degassed and deionized water, and a resultant aqueous solution was added to 6 mL of the above dispersion to obtain a liquid mixture. Next, to this liquid mixture, an aqueous sodium hydroxide solution (15 μL, 0.51 molL⁻¹, 7.5 μmol) was added. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 50 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a process was performed to wash the polymer particles included in the liquid mixture, which had been concentrated to approximately 8 mL. Specifically, degassed and deionized water (approximately 50 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

In Example 2, a portion (approximately 10 μL) of the concentrated liquid mixture obtained after the process of washing the polymer particles by the centrifugal filtration was diluted with degassed and deionized water (approximately 5.0 mL) to produce a sample for polymer particle measurement. This sample was used to measure the average particle diameter and the polydispersity index of the particle diameters of the polymer particles with a light scattering apparatus similar to that in Example 1. The results are shown in Table 4. Further, Table 4 also shows the rate of change in the average particle diameter and the rate of change in the polydispersity index of the particle diameters of the finally obtained polymer particles after the polymer particle washing (polymer particles B) relative to the polymer particles before the organotellurium group separation and the polymer particle washing (polymer particles A).

### Example 3

[Polymer Synthesis by Emulsion Polymerization]

In Example 3, a polymer was synthesized in a manner similar to that in Example 2. The polymer synthesized in Example 3 was measured for the number-average molecular weight Mₙ, the molecular weight dispersity, the average particle diameter, and the polydispersity index of the particle diameters in a manner similar to that in Example 1. The measurement results are shown in Table 2.

[Separation of Organotellurium Group from Growing End of Polymer]

As the reactant soluble in water which is the first solvent, p-mercaptobenzoic acid used in Example 1 was used. This thiol (7.5 μmol) and an aqueous sodium hydroxide solution (15 μL, 0.51 molL⁻¹, 7.5 μmol) were dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 50 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a step of washing the polymer particles included in the liquid mixture, which had been concentrated to approximately 8 mL, was performed as follows. First, degassed and deionized water (approximately 50 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

In Example 3, a portion (approximately 10 μL) of the concentrated liquid mixture obtained after the process of washing the polymer particles by the centrifugal filtration was diluted with degassed and deionized water (approximately 5.0 mL) to produce a sample for polymer particle measurement. This sample was used to measure the average particle diameter and the polydispersity index of the particle diameters of the polymer particles with a light scattering apparatus similar to that in Example 1. The results are shown in Table 4. Further, Table 4 also shows the rate of change in the average particle diameter and the rate of change in the polydispersity index of the particle diameters of the finally obtained polymer particles after the polymer particle washing (polymer particles B) relative to the polymer particles before the organotellurium group separation and the polymer particle washing (polymer particles A).

### Example 4

[Polymer Synthesis by Emulsion Polymerization]

In Example 4, a polymer was synthesized in a manner similar to that in Example 2. The polymer synthesized in Example 4 was measured for the number-average molecular weight Mₙ, the molecular weight dispersity, the average particle diameter, and the polydispersity index of the particle diameters in a manner similar to that in Example 1. The measurement results are shown in Table 2.

[Separation of Organotellurium Group from Growing End of Polymer]

As the reactant soluble in water which is the first solvent, p-mercaptobenzoic acid used in Example 1 was used. This thiol (7.5 μmol) and an aqueous sodium hydroxide solution (15 μL, 0.51 molL⁻¹, 7.5 μmol) were dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed methanol (approximately 50 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and a methanol solution separated from this liquid mixture.

Next, a step of washing the polymer particles included in the liquid mixture, which had been concentrated to approximately 8 mL, was performed as follows. First, degassed methanol (approximately 50 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the methanol solution separated by the n-th time centrifugal filtration is expressed as a methanol solution n. The tellurium concentrations in a methanol solution 1, a methanol solution 2, and a methanol solution 3 (total of three samples), each of which had been separated, were measured by ICP-AES described later. The tellurium recovery rates determined from the measurement results of the tellurium concentrations in the methanol solution 1, the methanol solution 2, and the methanol solution 3 were as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 5

[Polymer Synthesis by Emulsion Polymerization]

Under a nitrogen atmosphere, a polymerization control agent (1.6 mg, 5.0 μmol) and CTAB (260 mg, 4.3 mass % relative to water) were added to a glass tube. The polymerization control agent used was the organotellurium compound represented by the above structural formula (14), which had been used as the polymerization control agent in Example 2.

To the above glass tube, degassed and deionized water (6.0 mL) and an aqueous sodium hydroxide solution (10 μL, 0.51 molL⁻¹, 5.0 μmol) were further added to obtain a homogeneous solution. This solution was mixed with styrene (0.58 mL, 5.0 mmol) as a monomer to obtain a mixture. The mixture thus obtained was heated at 80° C. for 4 hours while stirring the mixture under a 6-W white light emitting diode (LED) lamp. Subsequently, the reaction mixture was removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of styrene reached 93% 4 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed for the number-average molecular weight Mₙ and the molecular weight dispersity by SEC as in Example 1. Further, another portion (approximately 10 μL) of the dispersion was diluted with deionized water (approximately 5.0 mL) to produce a sample for polymer particle measurement. This sample was used to measure the average particle diameter and the polydispersity index of the particle diameters of the polymer particles with a light scattering apparatus similar to that in Example 1. As for the polymer synthesized in Example 5, Table 2 shows the number-average molecular weight Mₙ, the molecular weight dispersity, the average particle diameter, and the polydispersity index of the particle diameters.

[Separation of Organotellurium Group from Growing End of Polymer]

As the reactant soluble in water which is the first solvent, 2-aminoethanethiol (HSCH₂CH₂NH₂) was used. This 2-aminoethanethiol (7.5 μmol) was dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed methanol (approximately 50 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and a methanol solution separated from this liquid mixture.

Next, a step of washing the polymer particles included in the liquid mixture, which had been concentrated to approximately 8 mL, was performed as follows. Degassed methanol (approximately 50 mL) was added to the concentrated liquid mixture (8 mL), and the resultant liquid mixture was concentrated to approximately 8 mL by a centrifugal filtration method similar to that in Example 1. This procedure was repeated twice.

### Example 6

[Polymer Synthesis by Emulsion Polymerization]

Under a nitrogen atmosphere, a polymerization control agent (1.5 mg, 5.0 μmol), polyoxyethylene (20), and oleyl ether (Brij98, 120 mg, 2 mass % relative to water) were added to a glass tube. The polymerization control agent used was the organotellurium compound represented by the above structural formula (13), which had been used as the polymerization control agent in Example 1.

To the above glass tube, degassed and deionized water (6.0 mL) and an aqueous sodium hydroxide solution (10 μL, 0.51 molL⁻¹, 5.0 μmol) were further added to obtain a homogeneous solution. This solution was mixed with butyl acrylate (0.69 mL, 5 mmol) as a monomer to obtain a mixture. The mixture thus obtained was heated at 65° C. for 12 hours while stirring the mixture under a 3-W white light emitting diode (LED) lamp. Subsequently, the reaction mixture was removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of butyl acrylate reached 81% 12 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed for the number-average molecular weight Mₙ and the molecular weight dispersity by SEC as in Example 1. Further, another portion (approximately 10 μL) of the dispersion was diluted with deionized water (approximately 5.0 mL) to produce a sample for polymer particle measurement. This sample was used to measure the average particle diameter and the polydispersity index of the particle diameters of the polymer particles with a light scattering apparatus similar to that in Example 1. As for the polymer synthesized in Example 6, Table 2 shows the number-average molecular weight Mₙ, the molecular weight dispersity, the average particle diameter, and the polydispersity index of the particle diameters.

[Separation of Organotellurium Group from Growing End of Polymer]

As the reactant soluble in water which is the first solvent, p-mercaptobenzoic acid used in Example 1 was used. This thiol (7.5 μmol) was dissolved in 2.0-mL degassed and deionized water, and a resultant aqueous solution was added to 6 mL of the above dispersion to obtain a liquid mixture. Next, to this liquid mixture, an aqueous sodium hydroxide solution (15 μL, 0.51 molL⁻¹, 7.5 μmol) was added. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 52 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a step of washing the polymer particles included in the liquid mixture, which had been concentrated to approximately 8 mL, was performed as follows. First, degassed and deionized water (approximately 52 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 7

[Polymer Synthesis by Emulsion Polymerization]

Under a nitrogen atmosphere, a polymerization control agent (1.6 mg, 5.0 μmol) and Brij98 (120 mg, 2 mass % relative to water) were added to a glass tube. The polymerization control agent used was the organotellurium compound represented by the above structural formula (14), which had been used as the polymerization control agent in Examples 2 to 4.

To the above glass tube, degassed and deionized water (6.0 mL) and an aqueous sodium hydroxide solution (10 μL, 0.51 molL⁻¹, 5.0 mol) were further added to obtain a homogeneous solution. This solution was mixed with butyl acrylate (0.69 mL, 5 mmol) as a monomer to obtain a mixture. The mixture thus obtained was heated at 65° C. for 12 hours while stirring the mixture under a 3-W white light emitting diode (LED) lamp. Subsequently, the reaction mixture was removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of butyl acrylate reached 91% 12 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed for the number-average molecular weight Mₙ and the molecular weight dispersity by SEC as in Example 1. Further, another portion (approximately 10 μL) of the dispersion was diluted with deionized water (approximately 5.0 mL) to produce a sample for polymer particle measurement. This sample was used to measure the average particle diameter and the polydispersity index of the particle diameters of the polymer particles with a light scattering apparatus similar to that in Example 1. As for the polymer synthesized in Example 7, Table 2 shows the number-average molecular weight Mₙ, the molecular weight dispersity, the average particle diameter, and the polydispersity index of the particle diameters.

[Separation of Organotellurium Group from Growing End of Polymer]

As the reactant soluble in water which is the first solvent, p-mercaptobenzoic acid used in Example 1 was used. This thiol (7.5 μmol) and an aqueous sodium hydroxide solution (15 μL, 0.51 molL⁻¹, 7.5 μmol) were dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 52 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a step of washing the polymer particles included in the liquid mixture, which had been concentrated to approximately 8 mL, was performed as follows. First, degassed and deionized water (approximately 52 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 8

[Polymer Synthesis by Emulsion Polymerization]

Under a nitrogen atmosphere, a polymerization control agent (5.0 μmol) and CTAB (5 mass % relative to water) were added to a glass tube. The polymerization control agent used was an organotellurium compound represented by the following formula (15). The organotellurium compound represented by the following formula (15) had a substituent having the highest hydrophilicity among the polymerization control agents used in the examples.

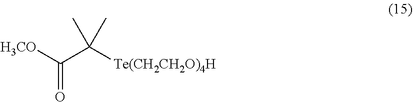

To the above glass tube, degassed and deionized water (6.0 mL) and an aqueous sodium hydroxide solution (10 μL, 0.51 molL⁻¹, 5.0 μmol) were further added to obtain a homogeneous solution. This solution was mixed with styrene (0.58 mL, 5.0 mmol) as a monomer to obtain a mixture. The mixture thus obtained was heated at 80° C. for 5 hours while stirring the mixture under a 6-W white light emitting diode (LED) lamp. Subsequently, the reaction mixture was removed by a small amount (approximately 100 μL), and organic substances were extracted with deuterated chloroform from the removed reaction mixture. After separation of the deuterated chloroform phase and drying, the degree of monomer conversion was measured by the ¹H NMR. The degree of conversion of styrene reached 98% 5 hours later. The reaction mixture finally obtained was a dispersion in which polymer particles were dispersed in water (corresponding to the first solvent).

The above dispersion was removed by a small amount (approximately 100 μL), and a polymer was extracted with chloroform from the removed reaction mixture. The polymer thus obtained was analyzed for the number-average molecular weight Mₙ and the molecular weight dispersity by SEC as in Example 1. Further, another portion (approximately 10 μL) of the dispersion was diluted with deionized water (approximately 5.0 mL) to produce a sample for polymer particle measurement. This sample was used to measure the average particle diameter and the polydispersity index of the particle diameters of the polymer particles with a light scattering apparatus similar to that in Example 1. As for the polymer synthesized in Example 8, Table 2 shows the number-average molecular weight Mₙ, the molecular weight dispersity, the average particle diameter, and the polydispersity index of the particle diameters.

[Separation of Organotellurium Group from Growing End of Polymer]

As the reactant soluble in water which is the first solvent, p-mercaptobenzoic acid used in Example 1 was used. This thiol (7.5 μmol) and an aqueous sodium hydroxide solution (15 μL, 0.51 molL⁻¹, 7.5 μmol) were dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 52 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a process was performed to wash the polymer particles included in the liquid mixture, which had been concentrated to approximately 8 mL. Specifically, degassed and deionized water (approximately 52 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 9

[Polymer Synthesis by Emulsion Polymerization]

In Example 9, a polymer was synthesized in a manner similar to that in Example 8 except for the change in heat treatment time in the polymerization from 5 hours to 3 hours. The degree of conversion of styrene reached 95% 3 hours later. The polymer synthesized in Example 9 was measured for the number-average molecular weight Mₙ, the molecular weight dispersity, the average particle diameter, and the polydispersity index of the particle diameters in a manner similar to that in Example 1. The measurement results are shown in Table 2.

[Separation of Organotellurium Group from Growing End of Polymer]

As the reactant soluble in water which is the first solvent, 2-aminoethanethiol (HSCH₂CH₂NH₂) was used. This 2-aminoethanethiol (7.5 μmol) was dissolved in 2.0-mL degassed and deionized water to prepare an aqueous solution. This aqueous solution was mixed with 6 mL of the above dispersion. The liquid mixture thus obtained was heated at 80° C. for 4 hours while stirring the liquid mixture under a 6-W white LED lamp.

The above liquid mixture after heating was increased in volume to 60 mL by adding degassed and deionized water (approximately 52 mL), and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and an aqueous solution separated from this liquid mixture.

Next, a process was performed to wash the polymer particles included in the liquid mixture, which had been concentrated to approximately 8 mL. Specifically, degassed and deionized water (approximately 52 mL) was added to the concentrated liquid mixture (8 mL), and the resultant liquid mixture was concentrated to approximately 8 mL by a centrifugal filtration method similar to that in Example 1. This procedure was repeated twice.

As in Example 1, the aqueous solution separated by the n-th time centrifugal filtration is expressed as an aqueous solution n. The tellurium concentrations in an aqueous solution 1, an aqueous solution 2, and an aqueous solution 3 (total of three samples), each of which had been separated, were measured by ICP-AES described later. The tellurium recovery rate determined from the measurement results of the tellurium concentrations in the aqueous solution 1, the aqueous solution 2, and the aqueous solution 3 was as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 10

[Polymer Synthesis by Emulsion Polymerization]

In Example 10, a polymer was synthesized in a manner similar to that in Example 6. That is, poly(n-butyl acrylate) was synthesized, and a dispersion in which the polymer particles were dispersed in water (corresponding to the first solvent) was obtained.

[Separation of Organotellurium Group from Growing End of Polymer]

As the reactant soluble in water which is the first solvent, p-mercaptobenzoic acid was used as in Example 6. This thiol (7.5 μmol) was dissolved in 2.0-mL degassed and deionized water, and a resultant aqueous solution was added to 6 mL of the above dispersion to obtain a liquid mixture. Next, to this liquid mixture, an aqueous sodium hydroxide solution (15 μL, 0.51 molL⁻¹, 7.5 μmol) was added. The liquid mixture thus obtained was heated at 80° C. for 4 hours while stirring the liquid mixture under a 6-W white LED lamp.

The above liquid mixture after heating was increased in volume to 60 mL by adding a solvent mixture (approximately 52 mL) of degassed and deionized water and methanol mixed in the volume ratio of water:methanol=1:1, and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and a solution separated from this liquid mixture. In this 1st time filtration, the filter for centrifugal filtration got clogged. This seems to be due to dissolution of poly(n-butyl acrylate) in methanol. Consequently, in Example 10, no subsequent washing was performed, and the concentrated liquid mixture including the polymer particles and the solution obtained by the 1st time filtration were used to measure the tellurium concentration in the solution by ICP-AES described later. The tellurium recovery rate was as shown in Table 3. Further, the concentrated liquid mixture was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

### Example 11

[Polymer Synthesis by Emulsion Polymerization]

In Example 11, a polymer was synthesized in a manner similar to that in Example 6. That is, poly(n-butyl acrylate) was synthesized, and a dispersion in which the polymer particles were dispersed in water (corresponding to the first solvent) was obtained.

[Separation of Organotellurium Group from Growing End of Polymer]

As the reactant soluble in water which is the first solvent, p-mercaptobenzoic acid was used as in Example 6. This thiol (7.5 μmol) was dissolved in 2.0-mL degassed and deionized water, and a resultant aqueous solution was added to 6 mL of the above dispersion to obtain a liquid mixture. Next, to this liquid mixture, an aqueous sodium hydroxide solution (15 μL, 0.51 molL⁻¹, 7.5 μmol) was added. The liquid mixture thus obtained was heated at 80° C. for 4 hours while stirring the liquid mixture under a 6-W white LED lamp.

The above liquid mixture after heating was increased in volume to 60 mL by adding a solvent mixture (approximately 52 mL) of degassed and deionized water and methanol mixed in the volume ratio of water:methanol=9:1, and the resultant liquid mixture was centrifuged and filtered in a manner similar to that in Example 1. This concentrated the liquid mixture to approximately 8 mL. That is, the above centrifugal filtration resulted in a concentrated liquid mixture including the polymer particles and a solution separated from this liquid mixture.

Next, a step of washing the polymer particles included in the liquid mixture, which had been concentrated to approximately 8 mL, was performed as follows. First, the above solvent mixture (approximately 52 mL) of water:methanol=9:1 (by volume ratio) was added to the concentrated liquid mixture (8 mL), and the resultant liquid mixture was concentrated to approximately 8 mL by a centrifugal filtration method similar to that in Example 1. This procedure was repeated twice.

As in Example 1, the solution separated by the n-th time centrifugal filtration is expressed as a solution n. The tellurium concentrations in a solution 1, a solution 2, and a solution 3 (total of three samples), each of which had been separated, were measured by ICP-AES described later. The tellurium recovery rates determined from the measurement results of the tellurium concentrations in the solution 1, the solution 2, and the solution 3 were as shown in Table 3. Further, the concentrated liquid mixture finally obtained was freeze-dried to obtain a polymer sample. The residual rate of tellurium in the polymer sample thus obtained was determined by using the theoretical initial tellurium concentration of 1,280 ppm. The residual concentration and residual rate of tellurium in the polymer sample are shown in Table 3.

(Tellurium Measurement by ICP-AES)

[Washing of Sample Containers]

For sample preparation for ICP-AES analysis, containers each formed from polytetrafluoroethylene (PTFE) or a copolymer with perfluorovinylpropyl ether (PFA) were used. These containers were each immersed in advance in an aqueous solution of a liquid detergent SCAT (registered trademark) for a day and in 3-molL⁻¹ hydrochloric acid for a day, then washed lastly with Milli-Q water, and stored in a sealable plastic bag.

To prepare a sample for tellurium concentration measurement, the target sample was heated and decomposed with use of nitric acid and hydrogen peroxide. Then, the sample was dried once and dissolved in an accurately weighed aqueous nitric acid solution. The intensity of the characteristic luminescence of tellurium at 214 nm and 238 nm was measured with an ICP-AES measurement device (Spectro Blue, manufactured by Spectro), and the concentration in the sample was determined by a calibration curve formed with use of a standard tellurium solution.

[Preparation of Sample for Tellurium Concentration Measurement from Filtrate]

The filtrate (aqueous solution or methanol solution) obtained by centrifugal filtration of the dispersion of the polymer particles was collected into a PFA container, and its mass was measured precisely. The amount of the filtrate to be collected was determined on the basis of the expected tellurium concentration in the sample. For example, for an expected tellurium concentration of about 10 ppm, the filtrate was collected by 10 mL. The PFA container was placed on a hot plate to dry the filtrate at 100° C. for 6 hours. After cooling to room temperature, concentrated nitric acid (2.0 mL) was added, and the resultant solution was heated again at 100° C. for 30 minutes to completely dissolve the solid. Subsequently, this solution was rinsed with concentrated nitric acid (3.0 mL) and quantitatively transferred to a cylindrical PTFE container for decomposition, to which a 30% hydrogen peroxide solution (0.5 mL) was added. The cylindrical container was sealed and heated at 200° C. or higher for 2 hours with a microwave heating device (Speed Wave MWS-3, manufactured by Analytik Jena GmbH) to completely decompose the sample. After cooling to room temperature, the sample solution was quantitatively transferred to a PFA container by rinsing with Milli-Q water, and dried on the hot plate at 160° C. for 6 hours. An accurately weighed aqueous nitric acid solution (3% solution, 10 mL) was added to the solid, and the resultant solid was heated at 80° C. overnight for complete dissolution. In the case where the solid remained, the solid was again subjected to a microwave heating process with nitric acid and a hydrogen peroxide solution. The solution was cooled to room temperature, and ICP-AES analysis was performed.

[Preparation of Sample for Tellurium Concentration Measurement from Polymer Sample]

The dried polymer sample was directly taken into a cylindrical PTFE container, and the mass was measured. The amount of the polymer to be collected was determined on the basis of the expected tellurium concentration in the sample. For example, for an expected tellurium concentration of approximately 10 ppm, the polymer was collected by approximately 0.1 g. Concentrated nitric acid (5.0 mL) and a 30 mass % hydrogen peroxide solution (0.5 mL) were added to the cylindrical container, and the cylindrical container was sealed. A process similar to the above was performed for the heating time of 4 hours for complete decomposition and dissolution.

[Calculation of Tellurium Concentration Based on Measurement by ICP-AES]

The intensity of the characteristic luminescence of tellurium at 214 nm and 238 nm was measured with an ICP-AES measurement device (Spectro Blue, manufactured by Spectro), and the concentration in the sample was determined by a calibration curve formed with use of a standard tellurium solution.

### Results on Examples 1 to 11

TABLE 2

| | | | Number- | | Average particle | Polydispersity |
|---|---|---|---|---|---|---|
| | Reaction | Degree of | average | Molecular | diameter of | index of particle |
| | time | conversion | molecular | weight | polymer particles | diameters of |
| Example | (hour) | (%) | weight Mₙ | dispersity | (nm) | polymer particles |
| 1 | 6 | 90 | 91.2 × 10³ | 1.26 | 200.4 | 0.50 |
| 2 | 3 | 95 | 97.6 × 10³ | 1.20 | 380.9 | 0.36 |
| 3 | 3 | 90 | 91.1 × 10³ | 1.18 | 328.4 | 0.39 |
| 4 | 3 | 91 | 91.0 × 10³ | 1.19 | 363.4 | 0.31 |
| 5 | 4 | 93 | 94.1 × 10³ | 1.21 | 336.2 | 0.35 |
| 6 | 12 | 81 | 118.2 × 10³ | 1.40 | 249.2 | 0.19 |
| 7 | 12 | 91 | 101.0 × 10³ | 1.20 | 143.0 | 0.15 |
| 8 | 5 | 98 | 118.6 × 10³ | 1.35 | 126.3 | 0.17 |
| 9 | 3 | 95 | 108.0 × 10³ | 1.37 | 106.4 | 0.22 |

TABLE 3

| | Solvent for dilution | Tellurium | Residual concentration/ |
|---|---|---|---|
| | and washing | recovery | Residual rate of tellurium |
| Example | (Second solvent) | rate (%) | in polymer (ppm/%) |
| 1 | Water: 1st to 3rd | 96.3 | 47.4/3.7 |
| | time filtrations | | |
| | Methanol: 4th and 5th | | |
| | time filtrations | | |
| 2 | Water | 48.3 | 682.2/53.3 |
| 3 | Water | 95.8 | 140.8/11.0 |
| 4 | Methanol | 99.2 | 6.4/0.5 |
| 5 | Methanol | — | — |
| 6 | Water | 51.1 | 599/46.8 |
| 7 | Water | 30.3 | 896/70.0 |
| 8 | Water | 95.3 | 73.0/5.7 |
| 9 | Water | 97.6 | 34.6/2.7 |
| 10 | Water/Methanol (1:1) | 66.8 | 332/33.2 |
| 11 | Water/Methanol (9:1) | 95.8 | 20/2.0 |

TABLE 4

| | Average particle | Polydispersity index of | Rate of change of | Rate of change of |
|---|---|---|---|---|
| | diameter of polymer | particle diameters of | average particle | polydispersity index of |
| Example | particles (nm) | polymer particles | diameter (%) | particle diameters (%) |
| 2 | 363.2 | 0.39 | −4.65 | +8.33 |
| 3 | 290.5 | 0.29 | −11.5 | −25.6 |

The dispersion used in Examples 1 to 11 was a dispersion in which polymer particles formed from a polymer including an organotellurium group at its growing end were dispersed in water that is the first solvent, where the polymer had been synthesized by an emulsion polymerization with use of an organotellurium compound as the polymerization control agent. In Examples 1 to 11, this dispersion was mixed with a water-soluble thiol, and the resultant liquid mixture was heated at 80° C. for 4 hours. Then, the centrifugal filtration was performed to separate, from the liquid mixture, the concentrated dispersion including the polymer particles and the solution which is the filtrate from each other. As shown in Table 3, in Examples 1 to 11, tellurium was contained in the filtrate obtained by the centrifugal filtration, and this tellurium seems to derive from the organotellurium group included at the growing end of the polymer. That is, the organotellurium group seems to have been able to be separated, by the method performed in Examples 1 to 11, from the polymer particles formed from the polymer including the organotellurium group at the growing end, where the polymer had been synthesized by an emulsion polymerization. Further, as confirmed in Examples 2 and 3, the polymer maintained the particle shapes even after separation of the organotellurium group. The results found that, according to the polymer particle manufacturing method according to the present invention, it is possible to separate, from polymer particles formed from a polymer having an organotellurium group bonded to its growing end, the organotellurium group while maintaining the particle shapes, thereby obtaining polymer particles having a reduced organotellurium group.

In Examples 1 and 4, methanol was used as the second solvent for: separating the polymer particles and the solution in which the organotellurium compound was dissolved from each other; and washing the polymer particles, where the organotellurium compound was generated by the reaction between the thiol and the organotellurium group bonded to the growing end of the polymer forming the polymer particles. Examples 1 and 4 in which methanol was used exhibited higher tellurium recovery rates than Examples 2 and 3 in which only water was used. The results found that, for the case where the polymer to be synthesized is polystyrene, tellurium can be recovered at a higher recovery rate by using alcohol in separation and washing than by using water.

In the organotellurium compound represented by the above formula (15) and used as the polymerization control agent in Examples 8 and 9, the hydroxy group at the ethylene oxide terminal bonded to tellurium has a high water solubility. Consequently, it was confirmed by UV-VIS analysis that the ditelluride generated from this organotellurium compound is water-soluble as well. In Example 9, since 2-aminoethanethiol (HSCH₂CH₂NH₂) was used as the reactant, the reduced product (Product 2) was almost quantitatively changed to a ditelluride and was separated from polystyrene. For the case of water as the solvent, the percentage of transition of tellurium to an aqueous phase in each washing step was measured by ICP-AES, exhibiting better results than those of Examples 1 to 5 and 8. Further, in Example 9, the residual amount of tellurium in the final polymer sample was 34.6 ppm (2.7%). The results found that the method used in Example 9 enables tellurium to be separated and recovered with a high efficiency.

In Examples 6, 7, 10, and 11, the polymer used was poly(n-butyl acrylate), which is a highly polar polymer, and organotellurium was separated and recovered from this polymer. In Examples 6 and 7, the solvent used for washing was water. In contrast, in Examples 10 and 11, a solvent mixture of water and methanol was used for washing. As can be seen from the results shown in Table 3, Examples 10 and 11 exhibited lower residual tellurium concentration in the polymer samples than Examples 6 and 7. This found that the present method exhibits good versatility for various polymer samples by using a solvent mixture of water and methanol for washing.

### INDUSTRIAL APPLICABILITY

The polymer particles obtained by the polymer particle manufacturing method according to the present invention have an extremely low tellurium concentration and have particle shapes such as particle diameters that can be highly controlled. Therefore, the polymer particles obtained by the present invention are applicable to all purposes including high-value-added applications to biomaterials and the like.

1. A polymer particle manufacturing method comprising:
(i) mixing a dispersion A of polymer particles A with a reactant, the dispersion A including the polymer particles A and a first solvent in which the polymer particles A are dispersed, the polymer particles A being formed from a structurally controlled polymer having an organotellurium group at a growing end thereof, the polymer being synthesized by an emulsion polymerization with use of a first organotellurium compound as a polymerization control agent, the reactant being soluble in the first solvent; and removing the organotellurium group from the growing end of the polymer to obtain a liquid mixture including a second organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the second organotellurium compound is dissolved from each other.

2. The polymer particle manufacturing method according to claim 1, wherein
in the step (i), the polymer particles B are obtained by removing the organotellurium group from the growing end of the polymer forming the polymer particles A while substantially maintaining shapes of the polymer particles A.

3. The polymer particle manufacturing method according to claim 1, wherein
the reactant is a reductant.

4. The polymer particle manufacturing method according to claim 1, wherein
the reactant has:
a first substituent reactive with the organotellurium group; and
at least one second substituent having an affinity for the first solvent.

5. The polymer particle manufacturing method according to claim 4, wherein
the first solvent includes water, and
the second substituent is at least one selected from the group consisting of a carboxy group, a salt of a carboxy group, an amino group, a salt of an amino group, an amide group, a hydroxy group, a sulfo group, a salt of a sulfo group, and an ether group.

6. The polymer particle manufacturing method according to claim 4, wherein
the first substituent is at least one selected from the group consisting of a thiol group, a tellurol group, and a selenol group.

7. The polymer particle manufacturing method according to claim 1, wherein
a tellurium concentration in the polymer particles B is 1000 mass ppm or less, and/or
the tellurium concentration represented by mass % in the polymer particles B is 70% or less of a tellurium concentration represented by mass % in the polymer particles A.

8. The polymer particle manufacturing method according to claim 1, further comprising
(iii) washing the polymer particles B obtained by the step (ii) with a second solvent, wherein
in the step (iii), the second organotellurium compound is further separated from the polymer particles B.

9. The polymer particle manufacturing method according to claim 8, wherein
the second solvent is a solvent that has an affinity for the first solvent and in which the polymer particles B are indissoluble.

10. The polymer particle manufacturing method according to claim 8, wherein
the first solvent includes water, and
the second solvent is a solvent that is indefinitely dilutable with water and in which the polymer particles B are indissoluble.

11. The polymer particle manufacturing method according to claim 10, wherein
the second solvent includes one solvent or a solvent mixture of two or more solvents selected from the group consisting of water, an alcohol, an amide, a ketone, and an alkyl sulfoxide.

12. The polymer particle manufacturing method according to claim 1, wherein
in the step (ii), a solid-liquid separation method is used for separating, from the liquid mixture, the polymer particles B and the solution in which the second organotellurium compound is dissolved from each other.

13. A polymer particle manufacturing method comprising:
(i) mixing a dispersion A of polymer particles A with a reactant, the dispersion A including the polymer particles A and a solvent in which the polymer particles A are dispersed, the polymer particles A being formed from a structurally controlled polymer having an organotellurium group at a growing end thereof, the reactant being soluble in the solvent; and removing the organotellurium group from the growing end of the polymer to obtain a liquid mixture including an organotellurium compound generated by a reaction between the reactant and the organotellurium group and polymer particles B having an organotellurium group reduced relative to the organotellurium group in the polymer particles A; and
(ii) separating, from the liquid mixture, the polymer particles B and a solution in which the organotellurium compound is dissolved from each other.

14-15. (canceled)

16. A dispersion of polymer particles, wherein
in the case where a polymer forming the polymer particles is a linear polymer, a molecular weight dispersity is 1 or more and 2 or less, and
in the case where the polymer forming the polymer particles is a branched polymer, the molecular weight dispersity is 1 or more and 4 or less,
a tellurium concentration in the polymer particles is more than 0 mass ppm and 1000 mass ppm or less, and
a polydispersity index of particle diameters of the polymer particles is 0.7 or less.

17. The dispersion of the polymer particles according to claim 16, wherein
an average particle diameter of the polymer particles is 1 nm or more and 100 μm or less.
